(19) United States
(12) Patent Application Publication
(10) Pub. No.: US 2014/0378612 A1
(43) Pub. Date: Dec. 25, 2014

(54) MOISTURE CURABLE ORGANOPOLYSILOXANE COMPOSITION

(71) Applicants: Sumi Dinkar, Bangalore (IN); Mihirkumar Patel Maheshbai, Bangalore (IN); Anantharaman Dhanabalan, Bangalore (IN)

(72) Inventors: Sumi Dinkar, Bangalore (IN); Mihirkumar Patel Maheshbai, Bangalore (IN); Anantharaman Dhanabalan, Bangalore (IN)

(21) Appl. No.: 14/369,424

(22) PCT Filed: Dec. 21, 2012
(86) PCT No.: PCT/US12/71329

§ 371 Date: Jun. 27, 2014

Related U.S. Application Data
(60) Provisional application No. 61/581,286, filed on Dec. 29, 2011.

(51) Int. Cl. C08K 3/36

(52) U.S. Cl. CPC C08K 3/36
USPC 524/860

(57) ABSTRACT

The present invention provides curable compositions comprising non-Sn organo-metal catalysts that accelerate the condensation curing of moisture curable silicones/non-silicones. In particular, the present invention provides Zn(II) and Zr(IV) complexes that are particularly suitable as replacements for organotin for sealant and RTV formulations. The Zn(II) and Zr(IV) complexes are comparable or superior to organotin such as DBTDL and exhibit certain behavior in the presence of components that allow for tuning or adjusting the cure characteristics of the present compositions and provide good adhesion and storage stability.

### CROSS-REFERENCE TO RELATED APPLICATIONS

This application claims the benefit of U.S. Provisional Patent Application No. 61/581,286 entitled “Moisture Curable Organopolysiloxane Compositions” filed on Dec. 29, 2011, which is hereby incorporated in its entirety by reference.

### FIELD

The present invention relates to curable compositions comprising curable polymers having reactive terminal silyl groups, and a zinc-based, a zirconium-based catalyst, or a combination thereof. In particular, the present invention provides curable compositions comprising Zn(II)-based and/or Zr(IV)-based complexes as an alternative to organotin catalysts.

### BACKGROUND

Polymers having reactive terminal silyl groups or compositions comprising such polymers can be hydrolyzed and condensed in the presence of water and organometal catalysts. Suitable known catalysts for curable compositions include organometallic compounds employing metals such as Sn, Ti, Zn or Ca. Organotin compounds such as, for example, dibutyltin dilaurate (DBTDL) are widely used as condensation cure catalysts to accelerate the moisture assisted curing of a number of different polyorganosiloxanes and non-silicone polymers having reactive terminal silyl groups such as room temperature vulcanizing (RTV) formulations including RTV-1 and RTV-2 formulations. Environmental regulatory agencies and directives, however, have increased or are expected to increase restrictions on the use of organotin compounds in formulated products. For example, while formulations with greater than 0.5 wt. % dibutyltin presently require labeling as toxic with reproductive 1B classification, dibutyltin-containing formulations are proposed to be completely phased out in consumer applications during next 4-6 years.

Alternative organotin compounds such as dioctyltin compounds and dimethyltin compounds can only be considered as a short-term remedial plan, as these organotin compounds may also be regulated in the future. It would be beneficial to identify non-Sn metal catalysts that accelerate the condensation curing of moisture curable silicones and non-silicones. Desirably, substitutes for organotin catalysts should exhibit properties similar to organotin compounds in terms of curing, storage, and appearance. Non-tin catalysts would also desirably initiate the condensation reaction of the selected polymers and complete this reaction upon the surface and may be in the bulk in a desired time schedule. There are therefore many proposals for the replacement of organometallic tin compounds by other organometallic compounds. These other metals have specific advantages and disadvantages in view of replacing tin compounds perfectly. Therefore, there is still a need to overcome some of the weaknesses of possible metal compounds as suitable catalyst for condensation cure reaction and behavior of uncured and cured compositions in particular to maintain the ability to adhere onto the surface of several substrates.

The use of zinc complexes as catalysts in condensation curable silicone compositions has been described. For example, U.S. Pub. Nos. 2011/0046304 and 2009/0156737, WO 2010/146253, and EP 1178150 describe the use of zinc compounds for silyl condensation cure chemistry. U.S. Pat. No. 5,985,991 broadly claims the use of various metals in a generic list of metal acetylacetonates consisting of Cu, Cr, Al, Zn, Ti, and Zr to improve the oil resistance of RTV silicone composition which comprises metal salt of carboxylic acid as a condensation cure catalyst. U.S. Pat. No. 5,945,466 broadly claims a generic list of organic metal compounds containing Sn, Ti, Zr, Pd, Zn, Co, Mn and Al as metallic element, as curing catalyst for room temperature curable organopolysiloxane composition which contains organosilane or its hydrolyzed product among other components.

U.S. Pat. No. 7,365,145 generically claims, a generic list of organic dibutyltin, zirconium complex, aluminum chelate, titanium chelate, organic zinc, organic cobalt, and organic nickel as catalysts in moisture curable silylated polymer composition. U.S. Publication No. 2009/0156737 claims a generic list of Lewis acid compounds of Ti, Zr, Hf, Zn, B, Al as catalysts in polymer blends comprising alkoxy silane terminated polymers and fillers.

U.S. Pat. No. 4,293,597 includes a generic list of metal salts including Pb, Sn, Zr, Sb, Cd, Ba, Ca, and Ti as catalysts in curable silicone rubber compositions that also contains nitrogen-functional silanes. U.S. Pat. No. 4,461,867 includes a generic list of metal esters also including Sn, Pb, Zr, Sb, Cd, Ba, Ca, Ti, Mn, Zn, Cr, Co, Ni, Al, Ga and Ge as a catalyst in moisture curable RTV-1 silicone compositions. U.S. Pub. No. 2011/0098420 includes a generic list including compounds of Pt, Pd, Pb, Sn, Zn, Ti and Zr, as dehydrogenative condensation reaction catalyst for a curable polysiloxane composition comprising of siloxanes with 2 or more hydrosilyl groups and siloxanes with 2 or more silanol groups. U.S. Pat. No. 7,527,838 claims a generic list of materials which includes metal catalysts based on Sn, Ti, Zr, Pb, Co, Sb, Mn and Zn, in curable diorganopolysiloxane compositions used for making insulated glass units.

Despite these general teachings that group zinc or zirconium complexes together with other metal complexes catalyze silyl condensation curing, there has not been provided any teachings or catalyst compositions that differentiate the catalytic activity exhibited by different zinc or zirconium complexes or a combination thereof. Further, there has not been a replacement catalyst for organo-tin compounds that maintains its ability to cure after storage over months in a sealed cartridge, when exposed to humidity or ambient air. It is always a specific requirement for moisture curable compositions to achieve the shortest possible curing times, showing a tack-free surface as well as a curing through the complete bulk in thick section for “One-Part” and “Two-Part” Room-Temperature Vulcanizing (RTV) compositions and provide a reasonable adhesion after cure onto a variety of substrates.

### SUMMARY

The present invention provides tin-free, curable compositions comprising silyl-terminated polymers and a non-toxic condensation catalyst based on zinc or zirconium complexes or a combination thereof. In particular, the present invention provides curable compositions employing a Zn(II)-based complex, a Zr (IV)-based complex, or a combination thereof as a condensation catalyst. In one aspect, the Zn(II)-based catalysts are complexes of the Formula (1):

Zn^{II}Y_{2-c}A_{c} (1)

and the Zr(IV)-based catalysts are complexes of the formula (2):

Zr^{IV}Y₄₋ₕAₕ (2)

wherein Y is a chelating ligand, A is an anion, c is a number between 0 to 2 or an integer, and h is a number between 0 to 4 or an integer.

In one aspect, the invention provides a curable composition exhibiting a relatively short tack-free time, curing through the bulk, as well as long storage stability in the cartridge, i.e., in the absence of humidity. The inventors have unexpectedly found that Zn(II) and Zr(IV) compounds and a combination thereof, including compounds of formulas (1) and (2), either on its own or in combination with certain adhesion promoter components and/or acidic compounds exhibit curing behavior similar to or even better than organotin compounds, and are therefore suitable as replacements for organotin catalysts in compositions having a reactive silyl-terminated polymer that can undergo condensation reactions such as in RTV-1 sealant and RTV-2 formulations.

Curable compositions using selected Zn(II) or Zr(IV) compounds or a combination thereof may also exhibit certain storage stability of the uncured composition in the cartridge, adhesion onto several surfaces, and a cure rate in a predictable time scheme.

In one aspect, the present invention provides a composition for forming a cured polymer composition comprising (A) a polymer having at least a reactive silylgroup; (B) a crosslinker or chain extender chosen from an alkoxysilane, an alkoxysiloxane, an oximosilane, an oximosiloxane, an enoxysilane, an enoxysiloxane, an aminosilane, a carboxysilane, a carboxysiloxane, an alkylamidosilane, an alkylamidosiloxane, an arylamidosilane, an arylamidosiloxane, an alkoxyaminosilane, an alkaryaminosiloxane, an alkoxycarbamatosilane, an alkoxycarbamatosiloxane, and combinations of two or more thereof; (C) about 0.01-7 parts per weight per 100 parts per weight of the polymer (A) of a catalyst selected from organometallic compounds or salts of zinc (II) (Zn(II)), zirconium (IV) (Zr(IV)), or combinations thereof; (D) at least one adhesion promoter chosen from a silane or siloxane other than the compounds listed under (B); (E) optionally, a filler component; and (F) optionally at least one acidic compound chosen from a phosphate ester, a phosphonate, a phosphite, a phosphine, a sulfite, a pseudohalogenide, a branched C₄-C₃₀-alkyl carboxylic acid, or a combination of two or more thereof.

In another embodiment, the catalyst compound (C) comprises a mixture of at least one Zn(II) complex and at least one Zr(IV) complex. Zinc and zirconium complexes are commercially available, and suitable materials include those available from King Industries, Inc. (trade name—K-KAT), Shepherd Chemicals, Reaxis and Gelest. In one embodiment, the catalyst composition may comprise from about 1 to about 99 wt. % of zinc and from about 1 to about 99 wt. % of zirconium; in another embodiment from about 5 to about 90 wt. % of zinc and from about 5 to about 90 wt. % of zirconium; in another embodiment from about 10 to about 80 wt. % of zinc and from about 10 to about 80 wt. % of zirconium; in another embodiment from about 20 to about 70 wt. % of zinc and from about 20 to about 70 wt. % of zirconium; and in another embodiment from about 30 to about 70 wt. % of zinc and from about 30 to about 70 wt. % of zirconium.

According to one embodiment, the catalyst comprises a zinc and/or zirconium catalyst according to formulas (1) and (2), and Y is a chelating ligand chosen from a diketonate, a diamine, a triamine, an aminoacetate, a nitriloacetate, a bipyridin, a glyoxime, or a combination of two or more thereof; A is an anion; c is a number between 0 to 2 or an integer, and g is 0 to 4 or an integer. According to one embodiment, the chelating agent Y comprises a substituted or unsubstituted diketonate. According to one embodiment, the anion A is selected from group which consists of substituted, unsubstituted C₄-C₂₅-alkyl-, C₇-C₂₅-arylalkyl, C₇-C₂₅-alkylaryl and C₆-C₁₀-aryl carboxylate anions. In one embodiment, the anion A is chosen from a branched C₄-C₁₉-alkyl carboxylic acid.

According to one embodiment, the component (F) is chosen from a mono ester of a phosphate; a phosphonate of the formula (R³O)PO(OH)₂, (R³O)P(OH)₂, or R³P(O)(OH)₂ where R³ is a C₁-C₁₈-alkyl, a C₂-C₂₀-alkoxyalkyl, phenyl, a C₇-C₁₂-alkylaryl, a poly(C₂-C₄-alkylene)oxide ester or its mixtures with diesters; a branched alkyl C₄-C₁₄-alkyl carboxylic acid; or a combination of two or more thereof.

In another aspect, the polymer (A) has the formula: [R¹ₐR²₃₋ₐSi—Z—]ₙ—X—Z—SiR¹ₐR²₃₋ₐ. In another embodiment, X is chosen from a polyurethane; a polyester; a polyether; a polycarbonate; a polyolefin; a polypropylene; a polyesterether; and a polyorganosiloxane having units of R₃SiO_{1/2}, R₂SiO, RSiO_{3/2}, and/or SiO_{4/2}, n is 0 to 100, a is 0 to 2, R and R¹ can be identical or different at the same Si-atom and chosen from a C₁-C₁₀-alkyl; a C₁-C₁₀-alkyl substituted with one or more of Cl, F, N, O or S; a phenyl; a C₇-C₁₆-alkylaryl; a C₇-C₁₆-arylalkyl; a C₂-C₄-polyalkylene ether; or a combination of two or more thereof. In yet another aspect, R² is chosen from OH, a C₁-C₈-alkoxy, a C₂-C₁₈-alkoxyalkyl, an oximoalkyl, an enoxyalkyl, an aminoalkyl, a carboxyalkyl, an amidoalkyl, an amidoaryl, a carbamatoalkyl, or a combination of two or more thereof, and Z is a bond, a divalent unit selected from the group of a C₁-C₈-alkylene, or O.

According to one embodiment, the crosslinker component (B) is chosen from tetraethylorthosilicate (TEOS), a polycondensate of TEOS, methyltrimethoxysilane (MTMS), vinyl-trimethoxysilane, methylvinyldimethoxysilane, dimethyldiethoxysilane, vinyltriethoxysilane, tetra-n-propylorthosilicate, vinyltris(methylethylketoxime)silane, methyltris(methylethylketoxime)silane, trisacetamidomethylsilane, bisacetamidodimethylsilane, tris(N-methyl-acetamido)methylsilane, bis(N-methylacetamido)dimethylsilane, (N-methyl-acetamido)methyldialkoxysilane, trisbenzamidomethylsilane, trispropenoxymethylsilane, alkyldialkoxyamidosilanes, alkylalkoxybisamidosilanes, CH₃Si(OC₂H₅)₁₋₂(NHCOR)₂₋₁, (CH₃Si(OC₂H₅)(NCH₃COC₆H₅)₂, CH₃Si(OC₂H₅)—(NHCOC₆H₅)₂, methyldimethoxy(ethylmethyl-ketoximo)silane; methylmethoxybis-(ethylmethylketoximo)silane; methyldimethoxy(acetal-doximo)silane; methyldimethoxy(N-methylcarbamato)silane; ethyldimethoxy(N-methyl-carbamato)silane; methyldimethoxyisopropenoxysilane; trimethoxyisopropenoxysilane; methyltri-isopropenoxysilane; methyldimethoxy(but-2-ene-2-oxy)silane; methyldimethoxy(1-phenylethenoxy)silane; methyldimethoxy-2(1-carboethoxypropenoxy)silane; methylmethoxydi-N-methylaminosilane; vinyldimethoxymethylaminosilane; tetra-N,N-diethylaminosilane; methyldimethoxymethylaminosilane; methyltricyclohexylaminosilane; methyldimethoxy-ethylaminosilane; dimethyldi-N,N-dimethylaminosilane; methyldimethoxyisopropylaminosilane dimethyldi-N,N-diethylaminosilane; ethyldimethoxy(N-ethylpropionamido)silane; methyldi-methoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(caprolactamo)silane; trimethoxy(N-methylacetamido)silane; methyldimethoxyethylacetimidatosilane; methyldimethoxy-propylacetimidatosilane; methyldimethoxy(N,N′,N′-trimethylureido)silane; methyldimethoxy(N-allyl-N′,N′-dimethylureido)silane; methyldimethoxy(N-phenyl-N′,N′-dimethylureido)silane; methyldimethoxyisocyanatosilane; dimethoxydiisocyanatosilane; methyldimethoxythioisocyanatosilane; methylmethoxydithioisocyanatosilane, or a combination of two or more thereof.

According to one embodiment, the adhesion promoter component (D) is chosen from an aminoalkyltrialkoxysilane, an aminoalkylalkyldialkoxysilane, a bis(alkyltrialkoxy-silyl)amine, a tris(alkyltrialkoxysilyl)amine, a tris(alkyltrialkoxy-silyl)cyanuarate, and a tris-(alkyl-trialkoxy-silyl)isocyanuarate, or a combination of two or more thereof.

According to one embodiment, the composition comprises about 1 to about 10 wt. % of the crosslinker component (B) based on 100 wt. % of the polymer component (A).

According to one embodiment, the crosslinker component (B) is chosen from a silane or a siloxane, the silane or siloxane having two or more reactive groups that can undergo hydrolysis and/or condensation reaction with polymer (A) or on its own in the presence of water and component (F).

According to one embodiment, the polymer component (A) is chosen from a polyorganosiloxane comprising divalent units of the formula [R₂SiO] in the backbone, wherein R is chosen from a C₁-C₁₀-alkyl; a C₁-C₁₀ alkyl substituted with one or more of Cl, F, N, O or S; a phenyl; a C₇-C₁₆ alkylaryl; a C₇-C₁₆ arylalkyl; a C₂-C₄ polyalkylene ether; or a combination of two or more thereof.

According to one embodiment, the catalyst (C) is present in an amount of from about 0.0.025 to about 0.7 wt. pt. per 100 wt. pt. of component (A).

According to one embodiment, the component (F) is present in an amount of from about 0.02 to about 3 wt. pt. per 100 wt. pt. of component (A).

According to one embodiment, the polymer component (A) has the formula: R²₃₋ₐR¹ₐSi—Z—[R₂SiO]ₓ[R¹₂SiO]_{y}—Z—SiR¹ₐR²₃₋ₐ whereby x is 0 to 10000; y is 0 to 1000; a is 0 to 2; R is methyl. In another aspect, R¹ is chosen from a C₁-C₁₀-alkyl; a C₁-C₁₀ alkyl substituted with one or more of Cl, F, N, O or S; a phenyl; a C₇-C₁₆ alkylaryl; a C₇-C₁₆ arylalkyl; a C₂-C₄ polyalkylene ether; or a combination of two or more thereof, and other siloxane units may be present in amounts less than 10 mol. % preferably methyl, vinyl, phenyl. In yet another embodiment, R² is chosen from OH, a C₁-C₈-alkoxy, a C₂-C₁₈-alkoxyalkyl, an oximoalkyl, an enoxyalkyl, an aminoalkyl, a carboxyalkyl, an amidoalkyl, an amidoaryl, a carbamatoalkyl, or a combination of two or more thereof, and Z is —O—, bond, or —C₂H₄—.

According to one embodiment, the composition further comprises a solvent chosen from an alkylbenzene, a trialkyphosphophate, a triarylphosphate, a phthalic acid ester, an arylsulfonic acid ester having a viscosity-density constant (VDC) of at least 0.86 that is miscible with a polyorganosiloxanes and catalyst component (C), a polyorganosiloxane devoid of reactive groups and having a viscosity of less than 2000 mPa·s at 25° C., or a combination of two or more thereof.

According to one embodiment, the composition is provided as a one part composition.

According to one embodiment, the composition comprises 100 pt. wt of component (A), 0.1 to about 10 pt. wt. of at least one crosslinker (B), 0.01 to about 7 pt. wt. of a catalyst (C), 0.1 to about 5 pt. wt. of an adhesion promoter (D), 0 to about 300 pt. wt. of component (E), 0.01 to about 8 pt. wt. of component (F) whereby this composition can be stored in the absence of humidity and is curable in the presence of humidity upon exposure to ambient air.

According to one embodiment, the composition is a two-part composition comprising: (i) a first portion comprising the polymer component (A), optionally the filler component (E), and optionally the acidic compound (F); and (ii) a second portion comprising the crosslinker (B), the catalyst component (C), the adhesive promoter (D), and the acidic compound (F), whereby (i) and (ii) are stored separately until applied for curing by mixing of the components (i) and (ii).

According to one embodiment, portion (i) comprises 100% wt. of component (A), and 0 to 70 pt. wt. of component (E); and portion (ii) comprises 0.1 to 10 pt. wt. of at least one crosslinker (B), 0.01 to 7 pt. wt. of a catalyst (C), 0 to 5 pt. wt. of an adhesion promoter (D), and 0.02 to 3 pt. wt. component (F).

In another aspect, the present invention provides a method of providing a cured material comprising exposing the composition to ambient air.

According to one embodiment, a method of providing a cured material comprises combining the first portion and the second portion and curing the mixture.

According to one embodiment, the composition is stored in a sealed cartridge or flexible bag having outlet nozzles for extrusion and/or shaping of the uncured composition prior to cure.

In still another aspect, the present invention provides a cured polymer material formed from the composition.

According to one embodiment, the cured polymer material is in the form of an elastomeric or duromeric seal, an adhesive, a coating including antifouling coating, an encapsulant, a shaped article, a mold, and an impression material.

The compositions are found to exhibit good storage stability and adhere to a variety of surfaces. In one embodiment, the curable compositions exhibit excellent adherence to thermoplastic surfaces, including polyacrylate and polymethylmethacrylate (PMMA) surfaces.

### DETAILED DESCRIPTION

The present invention provides a curable composition employing a zinc (Zn(II)) complex, a zirconium (Zr(IV)) complex, or a combination thereof as a condensation catalyst. The Zn(II) or Zr(IV) complexes identified in the present invention in combination with an adhesion promoter and optionally an acidic compound exhibit similar or superior curing properties as compared to compositions employing organotin compounds, such as DBTDL, in terms of accelerating moisture assisted condensation curing of silicones to result in cross-linked silicones that can be used as sealants and RTVs (Room-Temperature Vulcanized Rubber). The non-toxic nature of these zinc and zirconium compounds makes them more attractive and practical than organotin catalysts, given the forthcoming strict regulations on organotin catalysts.

The present invention provides a curable composition comprising a polymer component (A) comprising a reactive terminal silyl group; a cross-linker component (B); a catalyst component (C) comprising a Zn(II)-based complex, a Zr(IV)-based complex, or a combination of two or more thereof; an adhesion promoter component (D); an optional filler component (E); optionally an acidic compound (F); and optionally auxiliary components (G).

The polymer component (A) may be a liquid or solid-based polymer having a reactive terminal silyl group. The polymer component (A) is not particularly limited and may be chosen from any cross-linkable polymer as may be desired for a particular purpose or intended use. Non-limiting examples of suitable polymers for the polymer component (A) include polyorganosiloxanes (A1) or organic polymers free of siloxane bonds (A2), wherein the polymers (A1) and (A2) comprise reactive terminal silyl groups. In one embodiment, the polymer component (A) may be present in an amount of from about 10 to about 90 wt. % of the curable composition. In one embodiment, the curable composition comprises about 100 pt. wt. of the polymer component (A).

As described above, the polymer component (A) may include a wide range of polyorganosiloxanes. In one embodiment, the polymer component may comprise one or more polysiloxanes and copolymers of formula (3):

[R¹ₐR²₃₋ₐSi—Z—]ₙ—X—Z—SiR¹ₐR²₃₋ₐ (3)

R¹ may be chosen from saturated C₁-C₁₂ alkyl (which can be substituted with one or more of a halogen (e.g., Cl, F, O, S or N atom), C₅-C₁₆ cycloalkyl, C₂-C₁₂ alkenyl, C₇-C₁₆ arylalkyl, C₇-C₁₆ alkylaryl, phenyl, C₂-C₄ polyalkylene ether, or a combination of two or more thereof. Exemplary preferred groups are methyl, trifluoropropyl and/or phenyl groups.

R² may be a group reactive to protonated agents such as water and may be chosen from OH, C₁-C₈-alkoxy, C₂-C₁₈-alkoxyalkyl, amino, alkenyloxy, oximoalkyl, enoxyalkyl, aminoalkyl, carboxyalkyl, amidoalkyl, amidoaryl, carbamatoalkyl or a combination of two or more thereof. Exemplary groups for R² include OH, alkoxy, alkenyloxy, alkyloximo, alkylcarboxy, alkylamido, arylamido, or a combination of two or more thereof.

Z may be a bond, a divalent linking unit selected from the group of O_{1/2}, hydrocarbons which can contain one or more O, S or N atom, amide, urethane, ether, ester, urea units or a combination of two or more thereof. If the linking group Z is a hydrocarbon group then Z is linked to the silicon atom over a SiC bond. In one embodiment Z is chosen from a C₁-C₁₄ alkylene.

X is chosen from a polyurethane; a polyester; a polyether; a polycarbonate; a polyolefin; a polypropylene; a polyesterether; and a polyorganosiloxane having units of R₃SiO_{1/2}, R₂SiO, RSiO_{3/2}, and/or SiO_{4/2}, where R is chosen from a C₁-C₁₀-alkyl; a C₁-C₁₀ alkyl substituted with one or more of Cl, F, N, O or S; a phenyl; a C₇-C₁₆ alkylaryl; a C₇-C₁₆ arylalkyl; a C₂-C₄ polyalkylene ether; or a combination of two or more thereof X may be a divalent or multivalent polymer unit selected from the group of siloxy units linked over oxygen or hydrocarbon groups to the terminal silyl group comprising the reactive group R² as described above, polyether, alkylene, isoalkylene, polyester or polyurethane units linked over hydrocarbon groups to the silicon atom comprising one or more reactive groups R² as described above. The hydrocarbon group X can contain one or more heteroatoms such as N, S, O or P forming amides, esters, ethers urethanes, esters, ureas. In one embodiment, the average polymerization degree (Pₙ) of X should be more than 6, e.g. polyorganosiloxane units of R₃SiO_{1/2}, R₂SiO, RSiO_{3/2}, and/or SiO_{4/2}. In formula (3), n is 0-100; desirably 1, and a is 0-2, desirably 0-1.

Non-limiting examples of the components for unit X include polyoxyalkylene polymers such as polyoxyethylene, polyoxypropylene, polyoxybutylene, polyoxyethylene-polyoxypropylene copolymer, polyoxytetramethylene, or polyoxypropylene-polyoxybutylene copolymer; ethylene-propylene copolymer, polyisobutylene, polychloroprene, polyisoprene, polybutadiene, copolymer of isobutylene and isoprene, copolymers of isoprene or butadiene and acrylonitrile and/or styrene, or hydrocarbon polymer such as hydrogenated polyolefin polymers produced by hydrogenating these polyolefin polymers; polyester polymer manufactured by a condensation of dibasic acid such as adipic acid or phthalic acid and glycol, polycarbonates, or ring-opening polymerization of lactones; polyacrylic acid ester produced by radical polymerization of a monomer such as C₂-C₈-alkyl acrylates, vinyl polymers, e.g., acrylic acid ester copolymer of acrylic acid ester such as ethyl acrylate or butyl acrylate and vinyl acetate, acrylonitrile, methyl methacrylate, acrylamide or styrene; graft polymer produced by polymerizing the above organic polymer with a vinyl monomer; polysulfide polymer; polyamide polymer such as Nylon 6 produced by ring-opening polymerization of ε-caprolactam, Nylon 6.6 produced by polycondensation of hexamethylenediamine and adipic acid, etc., Nylon 12 produced by ring-opening polymerization of ε-aminolauro-lactam, copolymeric polyamides, polyurethanes, or polyureas.

Particularly suitable polymers include, but are not limited to, polysiloxanes, polyoxyalkylenes, saturated hydrocarbon polymers such as polyisobutylene, hydrogenated polybutadiene and hydrogenated polyisoprene, or polyethylene, polypropylene, polyester, polycarbonates, polyurethanes, polyurea polymers and the like. Furthermore, saturated hydrocarbon polymer, polyoxyalkylene polymer and vinyl copolymer are particularly suitable due to their low glass transition temperature which provide a high flexibility at low temperatures, i.e. below 0° C.

The reactive silyl groups in formula (3) can be introduced by employing silanes containing a functional group which has the ability to react by known methods with unsaturated hydrocarbons via hydrosilylation, or reaction of SiOH, aminoalkyl, HOOC-alkyl, HO-alkyl or HO-aryl, HS-alkyl or -aryl, Cl(O)C-alkyl or -aryl, epoxyalkyl or epoxycycloalkyl groups in the prepolymer to be linked to a reactive silyl group via condensation or ring-opening reactions. Examples of the main embodiments include the following: (i) siloxane prepolymers having a SiOH group that can undergo a condensation reaction with a silane (L-group)SiR¹ₐR²₃₋ₐ whereby a siloxy bond Si—O—SiR¹ₐR²₃₋ₐ is formed while the addition product of the leaving group (L-group) and hydrogen is released (L-group +H); (ii) silanes having an unsaturated group that is capable of reacting via a hydrosilylation or a radical reaction with a SiH group or radically activated groups of a silane such as SiH or an unsaturated group; and (iii) silanes including organic or inorganic prepolymers having OH, SH, amino, epoxy, —COCl, —COOH groups, which can react complementarily with epoxy, isocyanato, OH, SH, cyanato, carboxylic halogenides, reactive alkylhalogenides, lactones, lactams, or amines, that is to link the reactive prepolymer with the organofunctional silanes to yield a silyl functional polymer.

Silanes suitable for method (i) include alkoxysilanes, especially tetraalkoxysilanes, di- and trialkoxysilanes, di- and triacetoxysilanes, di- and triketoximatosilanes, di- and trialkenyloxysilanes, di- and tricarbonamidosilanes, wherein the remaining residues at the silicon atom of the silane are substituted or unsubstituted hydrocarbons. Other non-limiting silanes for method (i) include alkyltrialkoxysilanes, such as vinyltrimethoxysilane, methyltrimethoxysilane, propyltrimethoxysilane aminoalkyltrimethoxysilane, ethyltriacetoxysilane, methyl- or propyltriacetoxysilane, methyltributanonoximosilane, methyltripropenyloxysilane, methyltribenzamidosilane, or methyltriacetamidosilane. Prepolymers suitable for reaction under method (i) are SiOH-terminated polyalkylsiloxanes, which can undergo a condensation reaction with a silane having hydrolysable groups attached to the silicon atom. Exemplary SiOH-terminated polyalkydisiloxanes include polydimethylsilaxanes.

Suitable silanes for method (ii) include alkoxysilanes, especially trialkoxysilanes (HSi(OR)₃) such as trimethoxysilane, triethoxysilane, methyldiethoxysilane, methyldimethoxysilane, and phenyldimethoxysilane; methyldiacetoxysilane and phenyldiacetoxysilane. Hydrogenchlorosilanes are in principle possible but are less desirable due to the additional replacement of the halogen through an alkoxy, acetoxy group, etc. Other suitable silanes include organofunctional silanes having unsaturated groups which can be activated by radicals, such as vinyl, allyl, mercaptoalkyl, or acrylic groups. Non-limiting examples include vinyltrimethoxysilane, mercaptopropyltrimethoxysilane, methacryloxypropyltrimethoxysilane. Prepolymers suitable for reaction under method (ii) include vinyl terminated polyalkylsiloxanes, preferably polydimethylsiloxanes, hydrocarbons with unsaturated groups which can undergo hydrosilylation or can undergo radically induced grafting reactions with a corresponding organofunctional group of a silane comprising, for example, unsaturated hydrocarbon or a —SiH group.

Another method for introducing silyl groups into hydrocarbon polymers can be the copolymerization of unsaturated hydrocarbon monomers with the unsaturated groups of silanes. The introduction of unsaturated groups into a hydrocarbon prepolymer may include, for example, the use of alkenyl halogenides as chain stopper after polymerization of the silicon free hydrocarbon moiety.

Desirable reaction products between the silanes and prepolymers include the following structures:

—SiR₂O—SiR₂—CH₂—CH₂—SiR¹ₐR²₃₋ₐ, or (hydrocarbon)-[Z—SiR¹ₐR²₃₋ₐ]₁₋₅₀

Suitable silanes for method (iii) include, but are not limited to, alkoxysilanes, especially silanes having organofunctional groups to be reactive to —OH, —SH, amino, epoxy, —COCl, or —COOH.

In one embodiment, these silanes have an isocyanatoalkyl group such as gamma-isocyanatopropyltrimethoxysilane, gamma-isocyanatopropylmethyldimethoxysilane, gamma-isocyanatopropyltriethoxysilane, gamma-glycidoxypropylethyldimethoxysilane, gamma-glycidoxypropyltrimethoxysilane, gamma-glycidoxypropyltrimethoxysilane, gamma-(3,4-epoxycyclohexyl)ethyltrimethoxysilane, epoxylimonyltrimethoxysilane, N-(2-aminoethyl)-aminopropyltrimethoxysilane gamma-aminopropyltriethoxysilane, gamma-aminopropyltrimethoxysilane, gamma-aminopropylmethyldimethoxysilane, gamma-aminopropylmethyldiethoxysilane, etc.

In one embodiment, it is desirable to select either blocked amines or isocyanates (Z′—X)ₙ—Z′ for carrying out first a complete mixing and then the following coupling reaction. Examples of blocking agents are disclosed in EP 0947531 and other blocking procedures that employ heterocyclic nitrogen compounds such as caprolactam or butanone oxime, or cyclic ketones referred to in U.S. Pat. No. 6,827,875 both of which are incorporated herein by reference in their entirety.

Examples of suitable prepolymers for a reaction under method (iii) include, but are not limited to, polyalkylene oxides having OH groups, preferably with a high molecular weight (Mw) (weight average molecular weight >6000 g/mol) and a polydispersity M_{w}/Mₙ of less than 1.6; urethanes having remaining NCO groups, such as NCO functionalized polyalkylene oxides, especially blocked isocyanates. Prepolymers selected from the group of hydrocarbons having —OH, —COOH, amino, epoxy groups, which can react complementarily with an epoxy, isocyanato, amino, carboxyhalogenide or halogenalkyl group of the corresponding silane having further reactive groups useful for the final cure.

Suitable isocyanates for the introduction of a NCO group into a polyether may include tolulene diisocyanate, diphenylmethane diisocyanate, or xylene diisocyanate, or aliphatic polyisocyanate such as isophorone diisocyanate, or hexamethylene diisocyanate.

The polymerization degree of the unit X depends on the requirements of viscosity and mechanical properties of the cured product. If X is a polydimethylsiloxane unit, the average polymerization degree based on the number average molecular weight Mₙ is preferably 7 to 5000 siloxy units, preferably 200-2000 units. In order to achieve a sufficient tensile strength of >5 MPa, an average polymerization degree Pₙ of >250 is suitable whereby the polydimethylsiloxanes have a viscosity of more than 300 mPa·s at 25° C. If X is a hydrocarbon unit other than a polysiloxane unit, the viscosity with respect to the polymerization degree is much higher.

Examples of the method for synthesizing a polyoxyalkylene polymer include, but are not limited to, a polymerization method using an alkali catalyst such as KOH, a polymerization method using a transition metal compound porphyrin complex catalyst such as complex obtained by reacting an organoaluminum compound, a polymerization method using a composite metal cyanide complex catalyst disclosed, e.g., in U.S. Pat. Nos. 3,427,256; 3,427,334; 3,278,457; 3,278,458; 3,278,459; 3,427,335; 6,696,383; and U.S. Pat. No. 6,919,293.

If the group X is selected from hydrocarbon polymers, then polymers or copolymers having isobutylene units are particularly desirable due to its physical properties such as excellent weatherability, excellent heat resistance, and low gas and moisture permeability.

Examples of the monomers include olefins having 4 to 12 carbon atoms, vinyl ether, aromatic vinyl compound, vinylsilanes, and allylsilanes. Examples of the copolymer component include 1-butene, 2-butene, 2-methyl-1-butene, 3-methyl-1-butene, pentene, 4-methyl-1-pentene, hexene, vinylcyclohexene, methyl vinyl ether, ethyl vinyl ether, isobutyl vinyl ether, styrene, alpha-methylstyrene, dimethylstyrene, beta-pinene, indene, and for example, but not limited to, vinyltrialkoxysilanes, e.g. vinyltrimethoxysilane, vinylmethyldichlorosilane, vinyldimethylmethoxysilane, divinyldichlorosilane, divinyldimethoxysilane, allyltrichlorosilane, allylmethyldichlorosilane, allyldimethylmethoxysilane, diallyldichlorosilane, diallyldimethoxysilane, gamma-methacryloyloxypropyltrimethoxysilane, and gamma-methacryloyloxy-propylmethyldimethoxysilane.

In one embodiment, the polymer component (A) may be a polymer of formula (4):

R²₃₋ₐR¹ₐSi—Z—[R₂SiO]ₓ[R¹₂SiO]_{y}—Z—SiR¹ₐR²₃₋ₐ (4)

where R¹, R², and Z are defined as above with respect to formula (3); R is C₁-C₆-alkyl (an exemplary alkyl being methyl); a is 0-2, x is 0 to about 10,000; preferably 11 to about 2500; and y is 0 to about 1,000; preferably 0 to 500. In one embodiment, Z in a compound of formula (4) is a bond or a divalent C₂ to C₁₄-alkylene group, especially preferred is —C₂H₄—.

Non-limiting examples of suitable polysiloxane-containing polymers (A1) include, for example, silanol-stopped polydimethylsiloxane, silanol or alkoxy-stopped polyorganosiloxanes, e.g., methoxystopped polydimethylsiloxane, alkoxy-stopped polydimethylsiloxane-polydiphenylsiloxane copolymer, and silanol or alkoxy-stopped fluoroalkyl-substituted siloxanes such as poly(methyl 3,3,3-trifluoropropyl)siloxane and poly(methyl 3,3,3-trifluoropropyl)siloxane-polydimethyl siloxane copolymer. The polyorganosiloxane component (A1) may be present in an amount of about 10 to about 90 wt. % of the composition or 100 pt. wt. In one preferred embodiment, the polyorganosiloxane component has an average chain length in the range of about 10 to about 2500 siloxy units, and the viscosity is in the range of about 10 to about 500,000 mPa·s at 25° C.

Alternatively, the composition may include silyl-terminated organic polymers (A2) that are free of siloxane units, and which undergo curing by a condensation reaction comparable to that of siloxane containing polymers (A1). Similar to the polyorganosiloxane polymer (A1), the organic polymers (A2) that are suitable as the polymer component (A) include a terminal silyl group. In one embodiment, the terminal silyl group may be of the formula (5):

—SiR¹_{d}R²_{3-d} (5)

where R¹, R², and a are as defined above.

Examples of suitable siloxane free organic polymers include, but are not limited to, silylated polyurethane (SPUR), silylated polyester, silylated polyether, silylated polycarbonate, silylated polyolefins like polyethylene, polypropylene, silylated polyesterether and combinations of two or more thereof. The siloxane-free organic polymer may be present in an amount of from about 10 to about 90 wt. % of the composition or about 100 pt. wt.

In one embodiment, the polymer component (A) may be a silylated polyurethane (SPUR). Such moisture curable compounds are known in the art in general and can be obtained by various methods including (i) reacting an isocyanate-terminated polyurethane (PUR) prepolymer with a suitable silane, e.g., one possessing both hydrolyzable functionality at the silicon atom, such as, alkoxy, etc., and secondly active hydrogen-containing functionality such as mercaptan, primary or secondary amine, preferably the latter, etc., or by (ii) reacting a hydroxyl-terminated PUR (polyurethane) prepolymer with a suitable isocyanate-terminated silane, e.g., one possessing one to three alkoxy groups. The details of these reactions, and those for preparing the isocyanate-terminated and hydroxyl-terminated PUR prepolymers employed therein can be found in, amongst others: U.S. Pat. Nos. 4,985,491; 5,919,888; 6,207,794; 6,303,731; 6,359,101; and U.S. Pat. No. 6,515,164 and published U.S. Publication Nos. 2004/0122253 and U.S. 2005/0020706 (isocyanate-terminated PUR prepolymers); U.S. Pat. No. 3,786,081 and U.S. Pat. No. 4,481,367 (hydroxyl-terminated PUR prepolymers); U.S. Pat. Nos. 3,627,722; 3,632,557; 3,971,751; 5,623,044; 5,852,137; 6,197,912; and U.S. Pat. No. 6,310,170 (moisture-curable SPUR (silane modified/terminated polyurethane) obtained from reaction of isocyanate-terminated PUR prepolymer and reactive silane, e.g., aminoalkoxysilane); and, U.S. Pat. Nos. 4,345,053; 4,625,012; 6,833,423; and published U.S. Publication No. 2002/0198352 (moisture-curable SPUR obtained from reaction of hydroxyl-terminated PUR prepolymer and isocyanatosilane). The entire contents of the foregoing U.S. patent documents are incorporated by reference herein. Other examples of moisture curable SPUR materials include those described in U.S. Pat. No. 7,569,653, the disclosure of which is incorporated by reference in its entirety.

The polysiloxane composition may further include a crosslinker or a chain extender as component (B). In one embodiment, the crosslinker is of the formula (6):

R¹ₐSiR²₄₋ₐ (6)

wherein R² may be as described above, R¹ may be as described above, and a is 0-3. Alternatively, the cross-linker component may be a condensation product of formula (6) wherein one or more but not all R² groups are hydrolyzed and released in the presence of water and then intermediate silanols undergo a condensation reaction to give a Si—O—Si bond and water. The average polymerization degree can result in a compound having 2-10 Si units.

As used herein, the term crosslinker includes a compound including an additional reactive component having at least two hydrolysable groups and less than three silicon atoms per molecule not defined under (A). In one embodiment, the crosslinker or chain extender may be chosen from an alkoxysilane, an alkoxysiloxane, an oximosilane, an oximosiloxane, an enoxysilane, an enoxysiloxane, an aminosilane, a carboxysilane, a carboxysiloxane, an alkylamidosilane, an alkylamidosiloxane, an arylamidosilane, an arylamidosiloxane, an alkoxyaminosilane, an alkaryaminosiloxane, an alkoxycarbamatosilane, an alkoxycarbamatosiloxane, an imidatosilane, a ureidosilane, an isocyanatosilane, a thioisocyanatosilane, and combinations of two or more thereof. Examples of suitable cross-linkers include, but are not limited to, tetraethylorthosilicate (TEOS); methyltrimethoxysilane (MTMS); methyltriethoxysilane; vinyltrimethoxysilane; vinyltriethoxysilane; methylphenyldimethoxysilane; 3,3,3-trifluoropropyltrimethoxysilane; methyltriacetoxysilane; vinyltriacetoxysilane; ethyltriacetoxysilane; di-butoxydiacetoxysilane; phenyltripropionoxysilane; methyltris(methylethylketoxime)silane; vinyltris(methylethylketoxime)silane; 3,3,3-trifluoropropyltris(methylethylketoxime)silane; methyltris(isopropenoxy)silane; vinyltris(isopropenoxy)silane; ethylpolysilicate; dimethyltetraacetoxydisiloxane; tetra-n-propylorthosilicate; methyldimethoxy(ethylmethylketoximo)silane; methylmethoxybis-(ethylmethylketoximo)silane; methyldimethoxy(acetaldoximo)silane; methyldimethoxy(N-methylcarbamato)silane; ethyldimethoxy(N-methylcarbamato)silane; methyldimethoxyisopropenoxysilane; trimethoxyisopropenoxysilane; methyltri-iso-propenoxysilane; methyldimethoxy(but-2-ene-2-oxy)silane; methyldimethoxy(1-phenylethenoxy)silane; methyldimethoxy-2(1-carboethoxypropenoxy)silane; methylmethoxydi-N-methylaminosilane; vinyldimethoxymethylaminosilane; tetra-N,N-diethylaminosilane; methyldimethoxymethylaminosilane; methyltricyclohexylaminosilane; methyldimethoxyethylaminosilane; dimethyldi-N,N-dimethylaminosilane; methyldimethoxyisopropylaminosilane; dimethyldi-N,N-diethylaminosilane; ethyldimethoxy(N-ethylpropionamido)silane; methyldimethoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(caprolactamo)silane; trimethoxy(N-methylacetamido)silane; methyldimethoxyethylacetimidatosilane; methyldimethoxypropylacetimidatosilane; methyl dimethoxy(N,N′,N′-trimethylureido)silane; methyldimethoxy(N-allyl-N′,N′-dimethylureido)silane; methyldimethoxy(N-phenyl-N′,N′-dimethylureido)silane; methyldimethoxyisocyanatosilane; dimethoxydiisocyanatosilane; methyldimethoxythioisocyanatosilane; methylmethoxydithioisocyanatosilane, or combinations of two or more thereof. In one embodiment, the crosslinker may be present in an amount from about 1 to about 10 wt. % of the composition or from about 0.1 to about 10 pt. wt. per 100 pt. wt. of the polymer component (A). In another embodiment, the crosslinker may be present in an amount from about 0.1 to about 5 pt. wt. per 100 pt. wt. of the polymer component (A). In still another embodiment, the crosslinker may be present in an amount from about 0.5 to about 3 pt. wt. per 100 pt. wt. of the polymer component (A). Here as elsewhere in the specification and claims, numerical values may be combined to form new or undisclosed ranges.

Additional alkoxysilanes in an amount greater than 0.1 wt. % of component and (A) that are not consumed by the reaction between the prepolymer Z′—X—Z′ and which comprise additional functional groups selected from R⁴ can also work as an adhesion promoter and are defined and counted under component (D).

The curable compositions further comprise an organometal catalyst (C) comprising a Zn(II) complex, a Zr(IV) complex, or a combination of two or more thereof. The inventors have unexpectedly found that Zn(II) and Zr(IV) complexes, when used with an adhesion promoter and/or an acidic compound in accordance with aspects of the invention, exhibit excellent catalytic activity and are found to work satisfactorily in most of the compositions, e.g., typical sealant RTV1 or RTV2 formulations, comprising polymers having reactive terminal groups, which may additionally contain other ingredients. The Zn(II) or Zr(IV) complexes are typically liquid in nature and do not require a dispersion aid (e.g., a solvent). In the case of solid Zn(II) or Zr(IV) complexes, these are usually dispersed with the aid of an organic solvent.

In one embodiment, the catalysts component (C) comprises a Zn(II) complex of the formula (1), a Zr(IV) complex of the formula (2), or a combination of two or more thereof:

Zn^{II}Y_{2-c}A_{c} (1), or

Zr^{IV}Y₄₋ₕAₕ (2),

wherein Y is a chelating ligand, A is an anion, and c is 0 to 2 or an integer, and h is 0 to 4 or an integer.

The chelating ligand Y may be chosen from diketonates, diamines, triamines, aminoacetates, nitriloacteates, bipyridins, glyoximes, a carboxylate, combinations of two or more thereof, and the like. Examples of suitable chelating ligands include, but are not limited to, acetylacetonate-2,4-pentanedione (“AA” or “acac”); hexanedione-2,4; heptanedione-2,4; heptanedione-3,5; ethyl-3-pentanedione-2,4; methyl-5-hexanedione-2,4; octanedione-2,4; octanedione-3,5; dimethyl-5,5 hexanedione-2,4; methyl-6-heptanedione-2,4; dimethyl-2,2-nonanedione-3,5; dimethyl-2,6-heptanedione-3,5; 2-acetylcyclohexanone (Cy-acac); 2,2,6,6-tetramethyl-3,5-heptanedione (t-Bu-acac); 1,1,1,5,5,5-hexafluoro-2,4-pentanedione (F-acac); benzoylacetone; dibenzoyl-methane; 3-methyl-2,4-pentadione; 3-acetyl-pentane-2-one; 3-acetyl-2-hexanone; 3-acetyl-2-heptanone; 3-acetyl-5-methyl-2-hexanone; stearoylbenzoylmethane; octanoylbenzoylmethane; 4-t-butyl-4′-methoxy-dibenzoylmethane; 4,4′-dimethoxy-dibenzoylmethane; 4,4′-di-tert-butyl-dibenzoyl-methane, hexafluoroacetylacetone, or a combination of two or more thereof.

The anion A in formulas (1) or (2) is not particularly limited and may be chosen from anions including, but not limited to, halides, hydroxide, oxide, peroxide, ozonide, hydrosulfide, alkoxides, alkyl thio, nitride, acetate, amide, carboxylate, cyanide, cyanate, thiocyanate, carbonate, hydrogen carbonate and the like. Some specific examples of suitable anions include, but are not limited to, F⁻, Cl⁻, (I₃)⁻, [ClF₂]⁻, [IF₆]⁻, (ClO)⁻, (ClO₂)⁻, (ClO₃)⁻, (ClO₄)⁻, (OH)⁻, (SH)⁻, (SeH)⁻, (O₂)⁻, (O₃)⁻, (HS₂)⁻, (CH₃O)⁻, (C₂H_{S}O)⁻, (C₃H₇O)⁻, (CH₃S)⁻, (C₂H₅S)⁻, (C₂H₄CIO)⁻, (C₆H_{S}O)⁻, (C₆H₅S)⁻, [C₆H₄(NO₂)O]⁻, (HCO₂)⁻, (C₇H₅CO₂)⁻, (CH₃CO₂)⁻, (CH₃CH₂CO₂)⁻, (N₃)⁻, (CN)⁻, (NCO)⁻, (NCS)⁻, (NCSe)⁻, (NH₂)—, (PH₂)—, (ClHN)⁻, (Cl₂N)⁻, (CH₃NH)⁻, (HN═N)″, (H₂N—NH)⁻, (HP═P)⁻, (H₂PO)⁻, (H₂PO₂)⁻, and the like.

In one embodiment, the anion A is selected from group which consists of substituted, unsubstituted C₄-C₃₀-alkyl-, C₇-C₃₀-arylalkyl, C₇-C₃₀-alkylaryl and C₆-C₁₀-aryl carboxylate anions. The anion may be a carboxylate chosen from pentanoate, hexoate, heptoate, octoate, 2-ethyl hexanoate, neodeconate, etc., or a combination of two or more thereof. In one embodiment, the anion A is chosen from a branched C₄-C₃₀-alkyl carboxylic acid.

In one embodiment, the catalyst compound (C) comprises Zr(IV) 2-ethylhexanote. In another embodiment, the catalyst compound (C) comprises a mixture of at least one Zn(II) complex and at least one Zr(IV) complex. In an embodiment comprising a mixture of at least one Zn(II) complex and at least one Zr(IV) complex. The Zn(II) and Zr(IV) complexes may be provided separately as individual components or as part of a catalyst composition comprising a mixture or blend of such components. Where the Zn(II) and Zr(IV) complexes are provided as part of catalyst composition, the catalyst composition may comprise from about 1 to about 99 wt. % of zinc and from about 1 to about 99 wt. % of zirconium; in another embodiment from about 5 to about 90 wt. % of zinc and from about 5 to about 90 wt. % of zirconium; in another embodiment from about 10 to about 80 wt. % of zinc and from about 10 to about 80 wt. % of zirconium; in another embodiment from about 20 to about 70 wt. % of zinc and from about 20 to about 70 wt. % of zirconium; and in another embodiment from about 30 to about 70 wt. % of zinc and from about 30 to about 70 wt. % of zirconium. Here as elsewhere in the specification and claims, numerical values may be combined to form new and undisclosed ranges. Zinc and Zirconium complexes are commercially available, and suitable materials include those available from King Industries, Inc. (trade name—K-KAT), Shepherd Chemicals, Reaxis and Gelest.

In one embodiment, the Zn(II) complex, Zr(IV) complex, or mixture of such complexes may be added to the composition in an amount of from about 0.01 to about 7.0 pt. wt. related to 100 part per weight of component (A); from about 0.05 to about 5 pt. wt.; from about 0.1 to 2.5 pt. wt.; from about 0.5 to about 2 pt. wt.; even from about 1 to about 1.5 pt. wt. per 100 parts per weight of the polymer (A). In another embodiment the Zn(II) and/or Zr(IV) complexes may be added in an amount of from about 0.1 to about 5.0 pt. wt. In still another embodiment, the Zn(II) and/or Zr(IV) complex may be added in an amount of from about 0.15 to about 2.5 pt. wt. In still another embodiment, the Zn(II) and/or Zr(IV) complex may be present in an amount of about 0.2 to about 0.5 pt. wt. per 100 pt. wt. of component (A). Where the complexes are provided as part of a catalyst composition comprising a blend of zinc and zirconium complexes, the catalyst composition is present in an amount to provide a total catalyst concentration within the ranges described above. An increase in the amount of Zn(II) and/or Zr(IV) complex as a catalyst may increase the cure rate of curing the surface and decrease the cure time for a tack-free surface and the complete cure through the bulk. Furthermore, the amount of the Zn(II) or Zr(IV) complex added to the composition may affect the viscosity of the composition. Particularly, an increase in the amount of the Zn(II) or Zr(IV) complex may increase the final viscosity of the composition, which is less desirable.

The composition furthers include an adhesion promoter component (D) that is different to component (A) or (B). In one embodiment, the adhesion promoter (D) may be an organofunctional silane comprising the group R⁴, e.g., aminosilanes, and other silanes that are not identical to the silanes of component (B), or are present in an amount which exceeds the amount of silanes necessary for endcapping the polymer (A). The amount of non-reacted silane (B) or (D) in the reaction for making (A) can be defined in that after the endcapping reaction the free silanes are evaporated at a higher temperature up to 200° C. and vacuum up to 1 mbar to be more than 0.1 wt. % of (A).

Thus, some selected amines can advantageously be added to fine-tune the rate of the metal complex catalyzed condensation curing of silicone/non-silicone polymer containing reactive silyl groups, as desired.

In one embodiment, the composition comprises an adhesion promoter (D) comprising a group R⁴ as described by the general formula (7):

R⁴ₑR¹_{d}Si(OR³)_{4-d-e} (7)

where R⁴ is E-(CR⁵₂)_{f}—W—(CH₂)_{f}—; R¹ is as described above; d is 0, 1 or 2; e=1, 2 or 3; d+e=1 to 2; and f is 0 to 8, and may be identical or different.

Non-limiting examples of suitable compounds include:

E¹-(CR⁵₂)_{f}—W—(CH₂)_{f}SiR¹_{d}(OR³)_{3-d} (7a), or (7d)

E²-[(CR⁵₂)_{f}—W—(CH₂)_{f}SiR¹_{d}(OR³)_{3-d}]ₚ (7b) or (7f)

where p=2-3.

The group E may be selected from either a group E¹ or E². E¹ may be selected from a monovalent group comprising amine, —NH₂, —NHR, —(NHC₂H₅)₁₋₁₀NHR, NHC₆H₅, halogen, pseudohalogen, unsaturated aliphatic group with up to 14 carbon atoms, epoxy-group-containing aliphatic group with up to 14 carbon atoms, cyanurate-containing group, and an isocyanurate-containing group.

E² may be selected from a group comprising of a di- or multivalent group consisting of amine, polyamine, isocyanurate-containing and an isocyanurate-containing group, sulfide, sulfate, phosphate, phosphite and a polyorganosiloxane group, which can contain R⁴ and OR³ groups; W is selected from the group consisting of a single bond, a heteroatomic group selected from —COO—, —O—, epoxy, —S—, —CONH—, —HN—CO—NH— units; R⁵ is selected from hydrogen and R as defined above, R¹ may be identical or different as defined above, R³ is selected from the group, which consists of C₁-C₈-alkoxy, such as methoxy, ethoxy, C₃-C₁₂-alkoxyalkyl, C₂-C₂₂-alkylcarboxy and C₄-C₁₀₀-polyalkylene oxide may be identical or different.

Non-limiting examples of component (D) include:

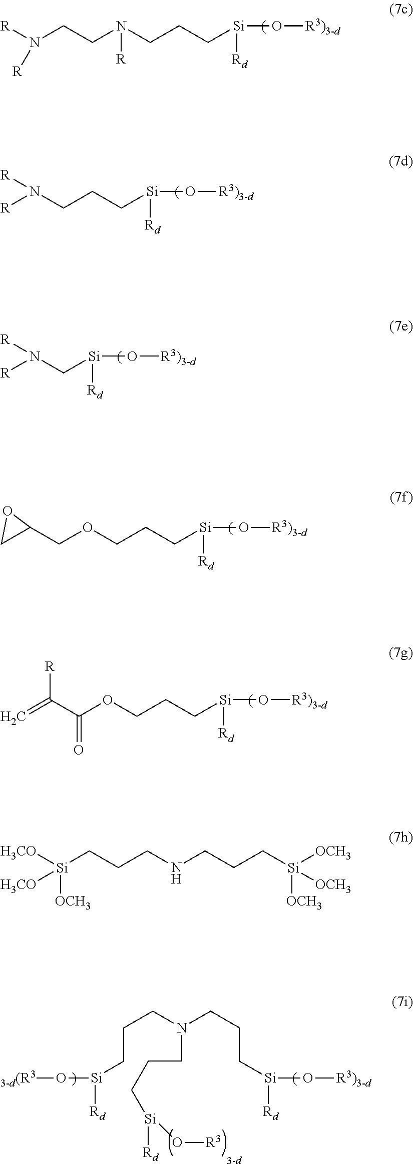

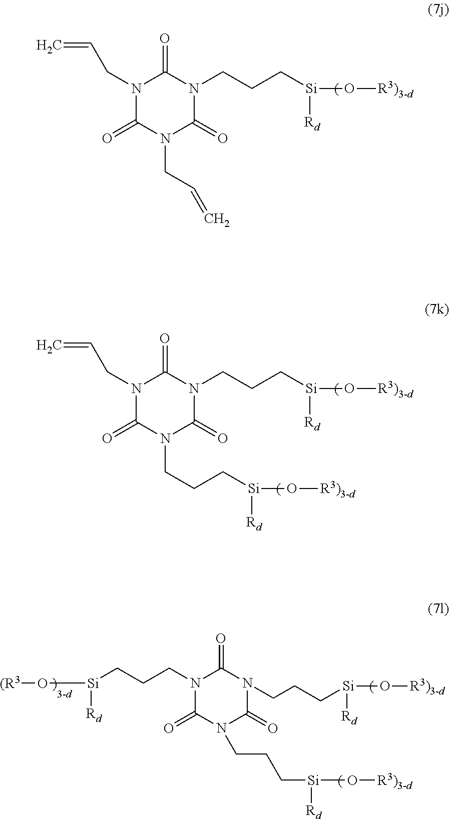

wherein R and d are as defined above. Examples of component (D) include compounds of the formulas (7a-7l). Furthermore the formula (7b) of compounds (D) shall comprise compounds of the formula (7m):

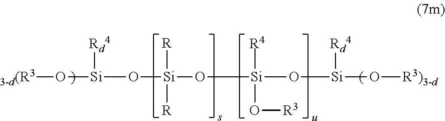

wherein: R, R¹, R³, and R⁴ are as defined above; R⁶ is hydrogen, R, linear and branched C₃-C₁₆ alkyl, C₅-C₁₄ cycloalkyl, phenyl, and phenyl substituted with C₁-C₈ alkyl; s is 0-6 (and in one embodiment desirably 0); u is 0-10 (in one embodiment desirably 0-5); and s+u is 10 or less. In one embodiment, R⁴ is selected from:

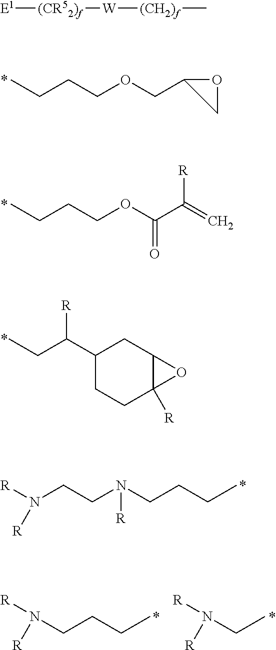

An exemplary group of adhesion promoters are selected from the group which consists of amino group-containing silane coupling agents. The amino group-containing silane adhesion promoter agent (D) is a compound having a group containing a silicon atom bonded to a hydrolyzable group (hereinafter referred to as a hydrolyzable group attached to the silicon atom) and an amino group. Specific examples thereof include the same silyl groups with hydrolyzable groups described above. Among these groups, the methoxy group and ethoxy group are particularly suitable. The number of the hydrolyzable groups may be 2 or more, and particularly suitable are compounds having 3 or more hydrolyzable groups.

Examples of other suitable adhesion promoter (D) include, but are not limited to N-(2-amino ethyl)aminopropyltrimethoxysilane gamma-aminopropyltriethoxysilane, gamma-aminopropyltrimethoxysilane, bis(gamma-trimethoxysilypropyl)amine, N-phenyl-gamma-aminopropyltrimethoxysilane, triaminofunctionaltrimethoxysilane, gamma-aminopropylmethyldimethoxysilane, gamma-aminopropylmethyldiethoxysilane, methacryloxypropyltrimethoxysilane, methylaminopropyltrimethoxysilane, gamma-glycidoxypropylethyldimethoxysilane, gamma-glycidoxypropyltrimethoxysilane, gamma-glycidoxyethyltrimethoxysilane, gamma-(3,4-epoxycyclohexyl)ethyltrimethoxysilane, beta-(3,4-epoxycyclohexyl)ethylmethyl-dimethoxysilane, epoxylimonyltrimethoxysilane, isocyanatopropyltriethoxysilane, isocyanatopropyltrimethoxysilane, isocyanatopropylmethyldimethoxysilane, beta-cyano-ethyl-trimethoxysilane, gamma-acryloxypropyl-trimethoxy-silane, gamma-methacryloxypropyl-methyldimethoxysilane, alpha,omega-bis-(aminoalkyl-diethoxysilyl)-polydimethylsiloxanes (Pn=1-7), alpha,omega-bis-(aminoalkyl-diethoxysilyl)-octa-methyltetrasiloxane, 4-amino-3,3,-dimethyl-butyl-tri-methoxysilane, and N-ethyl-3-tri-methoxy-silyl-2-methylpropanamine, 3-(diethyl-aminopropyl)-trimethoxysilane combinations of two or more thereof, and the like. Particularly suitable adhesion promoters include bis(alkyltrialkoxysilyl)amines and tris(alkyltrialkoxysilyl)amines including, but not limited to, bis(3-propyltrimethoxysilyl)amine and tris(3-propyltrimethoxysilyl)amine.

Also, it is possible to use derivatives obtained by modifying them, for example, amino-modified silyl polymer, silylated amino polymer, unsaturated aminosilane complex, phenylamino long-chain alkyl silane and aminosilylated silicone. These amino group-containing silane coupling agents may be used alone, or two or more kinds of them may be used in combination.

The curable compositions of the present invention may further comprise an alkoxysilane or blend of alkoxysilanes as an adhesion promoter (D). The adhesion promoter may be a combination blend of N-2-aminoethyl-3-aminopropyltrimethoxysilane and 1,3,5-tris(trimethoxy-silylpropyl)isocyanurate and others.

The adhesion promoter (D) may be present in an amount of from about 0.1 to about 5.0 pt. wt. based on 100 parts of the polymer component (A). In one embodiment, the adhesion promoter may be present in an amount of from about 0.15 to about 2.0 pt. wt. In another embodiment, the adhesion promoter may be present in an amount of from about 0.5 to about 1.5 pt. wt of the polymer component (A). This defines the amount of (D) in composition of (A) wherein the content of free silanes coming from the endcapping of polymer (A) is smaller than 0.1 wt. %.

The present compositions may further include a filler component (E). The filler component(s) (E) may have different functions, such as to be used as reinforcing or semi-reinforcing filler, i.e., to achieve higher tensile strength after curing having in addition the ability to increase the viscosity establish pseudoplasticity/shear thinning, and thixotropic behavior as well as non-reinforcing fillers acting mainly as a volume extender. The reinforcing fillers are characterized by having a specific surface area of more than 50 m²/g related BET-surface, whereby the semi-reinforcing fillers have a specific surface area in the range of 10-50 m²/g. So-called extending fillers have preferably a specific surface of less than 10 m²/g according to the BET-method and an average particle diameter below 100 um. In one embodiment, the semi-reinforcing filler is a calcium carbonate filler, a silica filler, or a mixture thereof. Examples of suitable reinforcing fillers include, but are not limited to fumed silicas or precipitated silica, which can be partially or completely treated with organosilanes or siloxanes to make them less hydrophilic and decrease the water content or control the viscosity and storage stability of the composition. These fillers are named hydrophobic fillers. Tradenames are Aerosil®, HDK®, Cab-O-Sil® etc.

Examples of suitable extending fillers include, but are not limited to, ground silicas (Celite™), precipitated and colloidal calcium carbonates (which are optionally treated with compounds such as stearate or stearic acid); reinforcing silicas such as fumed silicas, precipitated silicas, silica gels and hydrophobized silicas and silica gels; crushed and ground quartz, cristobalite, alumina, aluminum hydroxide, titanium dioxide, zinc oxide, diatomaceous earth, iron oxide, carbon black, powdered thermoplastics such as acrylonitrile, polyethylene, polypropylene, polytetrafluoroethylene and graphite or clays such as kaolin, bentonite or montmorillonite (treated/untreated), and the like.

The type and amount of filler added depends upon the desired physical properties for the cured silicone/non-silicone composition. As such, the filler may be a single species or a mixture of two or more species. The extending fillers can be present from about 0 to about 300 wt. % of the composition related to 100 parts of component (A). The reinforcing fillers can be present from about 5 to about 60 wt. % of the composition related to 100 parts of component (A), preferably 5 to 30 wt. %.

The inventive compositions may further comprise an acidic compound (F), which, in conjunction with the adhesion promoter and Zn(II) and/or Zr(IV) catalyst, has been found to accelerate curing (as compared to curing in the absence of such compounds). The component (F) may be present in an amount of from about 0.01 to about 5 wt. % of the composition. In another embodiment 0.01 to about 8 parts per weight (pt. wt.) per 100 pt. wt. of component (A) are used, more preferably 0.02 to 3 pt. wt. per 100 pt. wt. of component (A) and most preferably 0.02 to 1 pt. wt. per 100 pt. wt. of component (A) are used.

The acidic compounds (F) may be chosen from various phosphate esters, phosphonates, phosphites, phosphines, sulfites, pseudohalogenides, branched alkyl carboxylic acids, combinations of two or more thereof, and the like. Without being bound to any particular theory, the acidic compounds (F) may, in one embodiment, be useful as stabilizers in order to ensure a longer storage time when sealed in a cartridge before use in contact with ambient air. Especially alkoxy-terminated polysiloxanes can lose the ability to cure after storage in a cartridge and show e.g. decreased hardness under curing conditions. It may, therefore be useful to add compounds of the formula (8), which can extend storage time or ability to cure over months.

O═P(OR⁷)₃₋ᵣ(OH)ᵣ (8)

whereby r is 0, 1 or 2, and R⁷ is selected from the group a linear or branched and optionally substituted C₁-C₃₀-alkyl groups, linear or branched, C₅-C₁₄-cycloalkyl groups, C₆-C₁₄-aryl groups, C₆-C₃₁ alkylaryl groups, linear or branched C₂-C₃₀-alkenyl groups or linear or branched C₁-C₃₀-alkoxy-alkyl groups, C₄-C₃₀₀-polyalkenylene oxide groups (polyethers), such as Marlophor® N5 acid, triorganylsilyl- and diorganyl(C₁-C₈)-alkoxysilyl groups. The phoshates can include also mixtures of primary and secondary esters. Non-limiting examples of suitable phosphonates include 1-hydroxyethane-(1,1-diphosphonate) (HEDP), aminotrimethylene phosphonate (ATMP), nitrolotris(methylphosphonate) (NTMP), diethylenetriamine-pentakismethylene phosphonate (DTPMP), 1,2-diaminoethane-tetrakismethylene phosphonate (EDTMP), and phosphonobutanetricarbonate (PBTC).

In another embodiment, a compound of the formula O═P(OR⁷)₂₋ₜ(OH)ₜ may be added where t is 1 or 2, and R⁷ is as defined above or di- or mulitvalent hydrocarbons with one or more amino group.

Another type are phosphonic acid compounds of the formula O═PR⁷(OH)₂ such as alkyl phosphonic acids preferably hexyl or octyl phosphonic acid.

In one embodiment, the acidic compound may be chosen from a mono ester of a phosphate; a phosphonate of the formula (R³O)PO(OH)₂, (R³O)P(OH)₂, or R³P(O)(OH)₂ where R³ is a C₁-C₁₈-alkyl, a C₂-C₂₀-alkoxyalkyl, phenyl, a C₇-C₁₂-alkylaryl, a poly(C₂-C₄-alkylene)oxide ester or its mixtures with diesters, etc.

In another embodiment, the acidic compound is a branched alkyl C₄-C₃₀-alkyl carboxylic acids, including C₅-C₁₉ acids with alpha tertiary carbon, or a combination of two or more thereof. Examples of such suitable compounds include, but are not limited to, Versatic™ Acid, Laurie Acid, Steric Acid, etc. In one embodiment, the acidic compound may be a mixture comprising branched alkyl carboxylic acids. In one embodiment, the acidic compound is a mixture of mainly tertiary aliphatic C₁₀-carboxylic acids.

Applicants have found that the combination of a Zn(II) and/or Zr(IV) catalyst and an acidic compound may provide a curable composition that provides a cured polymer exhibiting a tack-free time, hardness, and/or cure time comparable to compositions made using tin catalysts, but that provide better adhesion compared to materials made using tin catalysts.

Generally, the acidic component (F) is added in a molar ratio of less than 1 with respect to catalyst (C). In embodiments, the acidic component (F) is added in a molar ratio of (F):(C) of 1:10 to 1:4.

The curable composition may also include auxiliary substances (G) such as plastizers, pigments, stabilizers, anti-microbial or fungicides, biocides and/or solvents. Preferred plastizers for reactive polyorganosiloxanes (A) are selected from the group of polyorganosiloxanes having chain length of 10-300 siloxy units. Preferred are trimethylsilyl terminated polydimethylsiloxanes having a viscosity of 100-1000 mPa·s at 25° C. The choice of optional solvents (dispersion media or extenders) may have a role in assuring uniform dispersion of the catalyst, thereby altering curing speed. Such solvents include polar and non-polar solvents such as toluene, hexane, chloroform, methanol, ethanol, isopropyl alcohol, acetone, methylethyl ketone, dimethylformamide (DMF), dimethyl sulfoxide (DMSO). Water can be an additional component (G) to accelerate fast curing 2 part compositions RTV 2-K, whereby the water can be in one part of the 2 compositions. Particularly suitable non-polar solvents include, but are not limited to, toluene, hexane and the like if the solvents should evaporate after cure and application. In another embodiment, the solvents include high boiling hydrocarbons such as alkylbenzenes, phthalic acid esters, arylsulfonic acid esters, trialkyl- or triarylphosphate esters, which have a low vapor pressure and can extend the volume providing lower costs. Examples cited by reference may be those of U.S. Pat. No. 6,599,633; U.S. Pat. No. 4,312,801. The solvent can be present in an amount of from about 20 to about 99 wt. % of the catalyst composition.

In one embodiment, a composition in accordance with the present invention comprises: 100 pt. wt. polymer component (A); about 0.1 to about 10 pt. wt. crosslinker component (B); about 0.01 to about 7 pt. wt. catalyst component (C); about 0.1 to about 5, in one embodiment 0.15-1 pt. wt., of an adhesion promoter component (D); about 0 to about 300 pt. wt. filler component (E); about 0.01 to about 7 pt. wt. of acidic compound (F); optionally 0 to about 15 pt. wt. component (G), where the pt. wt. of components (B)-(G) are each based on 100 parts of the polymer component (A). In one embodiment the composition comprises the component (F) in an amount of from about 0.01 to about 1 pt. wt. per 100 pt. wt. of component (A). In still another embodiment, the composition comprises the catalyst (C) in an amount of from about 0.1 to about 0.8 wt. pt. per 100 wt. pt of component (A).

It will be appreciated that the curable compositions may be provided as either a one-part composition or a two-part composition. A one-part composition refers to a composition comprising a mixture of the various components described above. A two-part composition may comprise a first portion and a second portion that are separately stored and subsequently mixed together just prior to application for curing. In one embodiment, a two-part composition comprises a first portion (P1) comprising a polymer component (A) and a crosslinker component (B), and a second portion (P2) comprising the catalyst component (C) comprising the Zn(II) and/or Zr(IV) complex. The first and second portions may include other components (F) and/or (G) as may be desired for a particular purpose or intended use. For example, in one embodiment, the first portion (P1) may optionally comprise an adhesion promoter (D) and/or a filler (E), and the second portion (P2) may optionally comprise auxiliary substances (G), a cure rate modifying component (F), and water (G).

In one embodiment, a two-part composition comprises (i) a first portion comprising the polymer component (A), optionally the filler component (E), and optionally the acidic compound (F); and (ii) a second portion comprising the crosslinker (B), the catalyst component (C), the adhesive promoter (D), and the acidic compound (F), where portions (i) and (ii) are stored separately until applied for curing by mixing of the components (i) and (ii).

An exemplary “Two-Part” composition comprises: a first portion (i) comprising 100 pt. wt of component (A), and 0 to 70 pt. wt of component (E); and a second portion (ii) comprising 0.1 to 5 pt. wt of at least one crosslinker (B); 0.01 to 2 pt. wt. of a catalyst (C); 0.1 to 2 p. wt. of an adhesion promoter (D); and 0.02 to 1 pt. wt. component (F).

The curable compositions may be used in a wide range of applications including as materials for sealing, mold making, adhesives, coatings in sanitary rooms, glazing, prototyping, joint seal between different materials, e.g., sealants between ceramic or mineral surfaces and thermoplastics, paper release, impregnation, and the like. A curable composition in accordance with the present invention comprising a Zn(II) and/or Zr(IV) complex as a catalyst may be suitable for a wide variety of applications such as, for example, a general purpose and industrial sealant, potting compound, caulk, adhesive or coating for construction use, insulated glass (IG), structural glazing (SSG), where glass sheets are fixed and sealed in metal frame; caulks, adhesives for metal plates, car bodies, vehicles, electronic devices and the like. Furthermore, the present composition may be used either as a one-part RTV-1K or as a two-part room temperature vulcanizing (RTV-2K) formulation which can adhere onto broad variety of metal, mineral, ceramic, rubber or plastic surfaces.

Curable compositions comprising Zn(II) or Zr(IV) catalyst compounds may be further understood with reference to the following Examples.

### EXAMPLES

### Zr- and/or Zn-Catalysts—General Experimental Procedure for ‘Two-Part’ Composition

To a mixture of 10 g of ethyl polysilicate (EPS), 0.3 g carboxylic acid, 5.0 g adhesion promoter, and a Zr(IV) 2-ethylhexonate catalyst (4 g) used as P2, 1000 g of silanol-stopped polydimethysiloxane having a viscosity of 600 mPa·s (25° C.) containing a silica filler used as P1 was added and mixed using a Hauschild mixer for 1.5 min. The mixed formulation was poured into a Teflon mold (length×breadth×depth˜10 cm×10 cm×1 cm) placed inside a fume hood. The surface curing (TFT) and bulk curing was monitored as a function of time (maximum of 7 days).

### Measurement of Surface Curing (TFT) and Bulk Curing

The surface cure was denoted by tack free time (TFT). In a typical TFT measurement, a stainless steel (SS) weight (weighing ˜10 g) was placed on the surface of the formulation spread on the Teflon mold to infer the tackiness of the surface, as whether any material is adhered to the surface of the SS weight or not. TFT is defined as the time taken for getting a non-tacky surface. Bulk curing is the time taken for complete curing of formulation throughout the thickness (i.e. Top to bottom) and it is monitored as a function of time (visual inspection).

### Measurement of the Storage Stability

For simulating the storage stability in a closed cartridge over several months the aforementioned “One-Part”-composition was submitted to an aging test. Hereby each of the closed cartridges comprising a single composition were kept in an oven for (1) 4 hours at 50° C., or (2) 5 days at 70° C., after which specified period the mixture is removed from oven and allow it to attain room temperature (25° C.). Then the mixtures were discharged by extrusion into a Teflon mold (length×breadth×depth˜10 cm×10 cm×1 cm) placed inside a fume hood in order to start the cure by interaction of ambient air having about 50% humidity at 25° C. The surface curing (TFT) and bulk curing was monitored as a function of time (maximum of 7 days) and Shore A hardness in order to determine to what extent the compositions maintained performance after storage under accelerated conditions. The increased temperature for the storage test should simulate the storage effect at room temperature (25° C. 50% relative humidity) over longer times in a kind of time lapse.

Table 1 illustrates the performance of the Zn(II)/Zr(IV) catalyst and its ligands as compared to a tin catalyst (DBTDL).

TABLE 1

| | Formulations | | | | | | | | |
|---|---|---|---|---|---|---|---|---|---|
| | Comp | Comp | Working | Working | Working | Working | Working | Working | Working |
| | Ex-1 | Ex-2 | Ex-1 | Ex-2 | Ex-3 | Ex-4 | Ex-5 | Ex-6 | Ex-7 |
| Component A | | | | | | | | | |
| Hydroxy end-capped PDMS | 66.33 | 66.33 | 66.33 | 66.33 | 66.33 | 66.33 | 66.33 | 66.33 | 66.33 |
| Treated fumed silica | 33.33 | 33.33 | 33.33 | 33.33 | 33.33 | 33.33 | 33.33 | 33.33 | 33.33 |
| Component B | | | | | | | | | |
| Ethyl polysilicate | 1 | 1 | 1 | 1 | 1 | 1 | 1 | 1 | 1 |
| Bis(3- | 0.5 | 0.5 | 0.5 | 0.5 | 0.5 | 0.5 | 0.5 | 0.5 | 0.5 |
| propyltrimethoxysilyl)amine | | | | | | | | | |
| Dibutyltin dilaurate | 0.1 | | | | | | | | |
| Zirconium(IV) | | | 0.2 | 0.1 | 0.05 | 0.025 | | | |
| 2-ethylhexanoate | | | | | | | | | |
| Zinc(II) neodecanoate | | | | | | | 0.05 | 0.025 | |
| Zinc(II) acetylacetonate | | | | | | | | | 0.05 |
| Versatic acid (VA10) | | | | | | | | | |
| Cure Properties | | | | | | | | | |
| Tack-free time (min) | 9 | 72 | 10 | 18 | 32 | 43 | 29 | 52 | 73 |
| Bulk cure time (h) | 6 | 24 | 7 | 8 | 9 | 9 | 9 | 10 | 14 |

| | Formulations | | | | | | | | |
|---|---|---|---|---|---|---|---|---|---|
| | Working | Working | Working | Working | Working | Working | Working | Working | Working |
| | Ex-8 | Ex-9 | Ex-10 | Ex-11 | Ex-12 | Ex-13 | Ex-14 | Ex-15 | Ex-16 |
| Component A | | | | | | | | | |
| Hydroxy end-capped PDMS | 66.33 | 66.33 | 66.33 | 66.33 | 66.33 | 66.33 | 66.33 | 66.33 | 66.33 |
| Treated fumed silica | 33.33 | 33.33 | 33.33 | 33.33 | 33.33 | 33.33 | 33.33 | 33.33 | 33.33 |
| Component B | | | | | | | | | |
| Ethyl polysilicate | 1 | 1 | 1 | 1 | 1 | 1 | 1 | 1 | 1 |
| Bis(3- | 0.5 | 0.5 | 0.5 | 0.5 | 0.5 | 0.5 | 0.5 | 0.5 | 0.5 |
| propyltrimethoxysilyl)amine | | | | | | | | | |
| Dibutyltin dilaurate | | | | | | | | | |
| Zirconium(IV) | 0.025 | 0.025 | 0.025 | 0.025 | | | 0.05 | | |
| 2-ethylhexanoate | | | | | | | | | |
| Zinc(II) neodecanoate | 0.025 | 0.025 | | | 0.025 | 0.025 | | 0.05 | |
| Zinc(II) acetylacetonate | | | 0.025 | 0.025 | 0.025 | 0.025 | | | 0.05 |
| Versatic acid (VA10) | | 0.04 | | 0.04 | | 0.04 | 0.04 | 0.04 | 0.04 |
| Cure Properties | | | | | | | | | |
| Tack-free time (min) | 26 | 19 | 51 | 24 | 30 | 18 | 14 | 15 | 38 |
| Bulk cure time (h) | 10 | 10 | 9 | 9 | 8 | 8 | 9 | 9 | 9 |

### Comments on Comparative Examples-1 & 2

A comparison of comparative examples 1 & 2 clearly indicates that the addition of dibutyltin dilaurate accelerates the silyl condensation curing of silicone.

### Comments on Working Examples 1-4

A comparison of working examples 1-4 with the comparative examples-1 & 2 indicates that Zr(IV)—2-ethylhexanoate indeed accelerates the silyl condensation curing of silicones, and that a similar catalytic activity to DBTDL can be achieved with the use of higher loading of Zr(IV)—2-ethylhexanoate (˜2× loading), as compared to the loading of dibutyltin dilaurate. An increase of cure time is evident with the use of a lower loading of Zr(IV)—2-ethylhexanoate.

### Comments on Working Examples 5-7

A comparison of working examples 5-7 with the working examples of 1-4 indicates that though a comparable acceleration of curing is evident with the use of Zn(II)-neodecanoate, as compared to the cure acceleration observed with the use of Zr(IV)—2-ethylhexanoate, a relatively less accelerated curing is evident with the use of Zn(II)-acetylacetone, at a similar loading level.

### Comments on Working Examples 8 & 9

A comparison of working examples 8 & 9 with the working examples of 1-6 indicates that a cure acceleration can be achieved with the use of a mixture of Zr(IV)—2-ethylhexanoate and Zn(II)-neodecanoate, instead of using them individually. The curing can further be accelerated with the use of versatic acid along with above mixture of catalysts (working example-9). The observed acceleration of curing with the addition of versatic acid is similar to those observed with the addition of versatic acid with individual catalysts (working examples-14 & 15).

### Comments on Working Examples 10 & 11

A comparison of working examples 10 & 11 with the working examples of 1-7 indicates that a cure acceleration can be achieved with the use of a mixture of Zr(IV)—2-ethylhexanoate and Zn(II)-acetylacetonate, instead of using them individually. The curing can further be accelerated with the use of versatic acid along with above mixture of catalysts (working example—11).

### Comments on Working Examples 12 & 13

A comparison of working examples 12 & 13 with the working examples of 5-7 indicates that a cure acceleration can be achieved with the use of a mixture of Zn(II)-neodecanoate and Zn(II)-acetylacetonate, instead of using them individually. The curing can further be accelerated with the use of versatic acid along with above mixture of catalysts (working example—13).

Embodiments of the invention have been described above and modifications and alterations may occur to others upon the reading and understanding of this specification. The claims as follows are intended to include all modifications and alterations insofar as they come within the scope of the claims or the equivalent thereof.

We claim:

1. A composition for forming a cured polymer composition comprising:
(A) a polymer having at least a reactive silylgroup;
(B) a crosslinker or chain extender chosen from an alkoxysilane, an alkoxysiloxane, an oximosilane, an oximosiloxane, an enoxysilane, an enoxysiloxane, an aminosilane, a carboxysilane, a carboxysiloxane, an alkylamidosilane, an alkylamidosiloxane, an arylamidosilane, an arylamidosiloxane, an alkoxyaminosilane, an alkaryaminosiloxane, an alkoxycarbamatosilane, an alkoxycarbamatosiloxane, and combinations of two or more thereof;
(C) a catalyst chosen from an organometalic compound or salt of zinc(II), zirconium (IV), or a combination of two or more thereof;
(D) at least one adhesion promoter chosen from a silane or siloxane other than the compounds listed under (B);
(E) optionally, a filler component; and
(F) optionally, at least one acidic compound chosen from a phosphate ester, a phosphonate, a phosphite, a phosphine, a sulfite, a pseudohalogenide, a branched alkyl carboxylic acid, and a combination of two or more thereof.

2. The composition of claim 1, wherein the metal catalyst component (C) comprises a Zn(II) complex of the formula (1):
Zn^{II}Y_{3-c}A_{c} (1),
a Zr(IV) complex of the formula (2):
Zr^{IV}Y₄₋ₕAₕ (2),
or a combination of two or more thereof, wherein Y is a chelating ligand chosen from a diketonate, a diamine, a triamine, an aminoacetate, a nitriloacetate, a bipyridin, a glyoxime, or a combination of two or more thereof; and A is an anion chosen from substituted, unsubstituted alkyl- and aryl carboxylates, c is a number between 0 to 2 or an integer, and h is a number between 0 to 4 or an integer.

3. The composition of claim 2, wherein the chelating agent Y comprises a substituted diketonate, the carboxylate anion A is chosen from pentanoate, hexanoate, heptanoate, octoate, neodecanoate, 2-ethylhexanoate, or a combination of two or more thereof.

4. The composition of claim 2, wherein catalyst (C) comprises a blend of a Zn(II) complex and a Zr(IV) complex or a blend of two Zn(II) complexes or a blend of two Zr(IV) complexes.

5. The composition of claim 4, wherein the catalyst (C) comprises a composition comprising from about 1 to about 99 wt. % of zinc and from about 1 to about 99 wt. % of zirconium.

6. The composition of claim 4, wherein the catalyst (C) comprises a composition comprising from about 10 to about 80 wt. % of zinc and from about 10 to about 80 wt. % of zirconium.

7. The composition of claim 4, wherein the catalyst (C) comprises a composition comprising from about 30 to about 70 wt. % of zinc and from about 30 to about 70 wt. % of zirconium.

8. The composition of claim 2, wherein catalyst (C) comprises a complex Zr^{IV}Y_{4-g}A_{g} and whereby g=4 and the anion A is a branched C₄-C₃₀ alkyl carboxylate.

9. The composition of claim 1 comprising from about 0.01 to about 7 parts per weight of catalyst (C) per 100 parts per weight of the polymer A.

10. The composition of claim 1, comprising component (C) in an amount of about 0.05 to about 5 parts per weight per 100 parts per weight of the polymer (A).

11. The composition of claim 1, comprising component (C) in an amount of about 0.01 to about 1.0 parts per weight per 100 parts per weight of the polymer (A).

12. The composition of claim 1, comprising component (C) in an amount of about 0.02 to about 0.4 parts per weight per 100 parts per weight of the polymer (A).

13. The composition of claim 1, wherein the acidic component (F) is added in a molar ratio of (F):(C) of 1:10 to 1:4.

14. The composition of claim 1, wherein the component (F) is chosen from a mono ester of a phosphate; a phosphonate of the formula (R³O)PO(OH)₂, (R³O)P(OH)₂, or R³P(O)(OH)₂ where R³ is a C₁-C₁₈-alkyl, a C₂-C₂₀-alkoxyalkyl, phenyl, a C₇-C₁₂-alkylaryl, a poly(C₂-C₄-alkylene)oxide ester or its mixtures with diesters; a branched alkyl C₄-C₃₀-alkyl carboxylic acid; or a combination of two or more thereof.

15. The polymer composition of claim 1, wherein the polymer (A) has the formula (2)
[R¹ₐR²₃₋ₐSi—Z—]ₙ—X—Z—SiR¹ₐR²₃₋ₐ (2)
where X is chosen from a polyurethane; a polyester; a polyether; a polycarbonate; a polyolefin; a polypropylene; a polyesterether; and a polyorganosiloxane having units of R³SiO_{1/2}, R²SiO, RSiO_{3/2}, and/or SiO_{4/2},
n is 0 to 100,
a is 0 to 2,
R and R¹ can be identical or different at the same Si-atom and chosen from a C₁-C₁₀-alkyl; a C₁-C₁₀ alkyl substituted with one or more of Cl, F, N, O or S; a phenyl; a C₇-C₁₆ alkylaryl; a C₇-C₁₆ arylalkyl; a C₂-C₄ polyalkylene ether; or a combination of two or more thereof.
R² is chosen from OH, a C₁-C₈-alkoxy, a C₂-C₁₈-alkoxyalkyl, an oximoalkyl, an enoxyalkyl, an aminoalkyl, a carboxyalkyl, an amidoalkyl, an amidoaryl, a carbamatoalkyl, or a combination of two or more thereof, and
Z is a bond, a divalent unit selected from the group of a C₁-C₈ alkylene, or O.

16. The composition of claim 1, wherein the crosslinker component (B) is chosen from tetraethylorthosilicate (TEOS), a polycondensate of TEOS; methyltrimethoxysilane (MTMS); vinyl-trimethoxysilane; methylvinyldimethoxysilane; dimethyldiethoxysilane; vinyltriethoxysilane; tetra-n-propylorthosilicate; vinyltris(methylethylketoxime)silane; methyltris(methylethylketoxime)silane; trisacetamidomethylsilane; bisacetamidodimethylsilane; tris(N-methyl-acetamido)methylsilane; bis(N-methylacetamido) dimethylsilane; (N-methyl-acetamido)methyldialkoxysilane; trisbenzamidomethylsilane; trispropenoxymethylsilane; alkyldialkoxyamidosilanes; alkylalkoxybisamidosilanes; CH₃Si(OC₂H₅)₁₋₂(NHCOR)₂₋₁; (CH₃Si(OC₂H₅)(NCH₃COC₆H₅)₂; CH₃Si(OC₂H₅)—(NHCOC₆H₅)₂; methyldimethoxy(ethylmethylketoximo)silane; methylmethoxybis-(ethylmethylketoximo)silane; methyldimethoxy(acetaldoximo)silane; methyldimethoxy(N-methylcarbamato)silane; ethyldimethoxy(N-methylcarbamato)silane; methyldimethoxyisopropenoxysilane; trimethoxyisopropenoxysilane; methyltri-iso-propenoxysilane; methyldimethoxy(but-2-ene-2-oxy)silane; methyldimethoxy(1-phenylethenoxy)silane; methyldimethoxy-2(1-carboethoxypropenoxy)silane; methylmethoxydi-N-methylaminosilane; vinyldimethoxymethylaminosilane; tetra-N,N-diethylaminosilane; methyldimethoxymethylaminosilane; methyltricyclohexylaminosilane; methyldimethoxyethylaminosilane; dimethyldi-N,N-dimethylaminosilane; methyldimethoxyisopropylaminosilane; dimethyldi-N,N-diethylaminosilane; ethyldimethoxy(N-ethylpropionamido)silane; methyldimethoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(caprolactamo)silane; trimethoxy(N-methylacetamido)silane; methyldimethoxyethylacetimidatosilane; methyldimethoxypropylacetimidatosilane; methyldimethoxy(N,N′,N′-trimethylureido)silane; methyldimethoxy(N-allyl-N′,N′-dimethylureido)silane; methyldimethoxy(N-phenyl-N′,N′-dimethylureido)silane; methyldimethoxyisocyanatosilane; dimethoxydiisocyanatosilane; methyldimethoxythioisocyanatosilane; methylmethoxydithioisocyanatosilane, or a combination of two or more thereof.

17. The composition of claim 1, wherein the adhesion promoter component (D) is chosen from an aminoalkyltrialkoxysilane, an aminoalkylalkyldialkoxysilane, a bis(alkyltrialkoxysilyl)amine, a tris(alkyltrialkoxysilyl)amine, a tris(alkyltrialkoxysilyl)cyanuarate, and a tris(alkyltrialkoxysilyl)isocyanuarate, or a combination of two or more thereof.

18. The polymer composition of claim 1 wherein the polymer component (A) has the formula (4):
R²₃₋ₐR¹ₐSi—Z—[R²SiO]ₓ[R¹₂SiO]_{y}—Z—SiR¹ₐR²₃₋ₐ (4)
whereby
x is 0 to 10000;
y is 0 to 1000;
a is 0 to 2;
R is methyl;
R¹ is chosen from a C₁-C₁₀-alkyl; a C₁-C₁₀ alkyl substituted with one or more of Cl, F, N, O or S; a phenyl; a C₇-C₁₆ alkylaryl; a C₇-C₁₆ arylalkyl; a C₂-C₄ polyalkylene ether; or a combination of two or more thereof, and other siloxane units may be present in amounts less than 10 mol. %;
R² is chosen from OH, a C₁-C₈-alkoxy, a C₂-C₁₈-alkoxyalkyl, an oximoalkyl, an enoxyalkyl, an aminoalkyl, a carboxyalkyl, an amidoalkyl, an amidoaryl, a carbamatoalkyl, or a combination of two or more thereof, and
Z is —O—, bond, or —C₂H₄—.

19. The composition of claim 1, further comprising a solvent chosen from an alkylbenzene, a trialkyphosphate, a triarylphosphate, a phthalic acid ester, an arylsulfonic acid ester having a viscosity-density constant (VDC) of at least 0.86 that is miscible with a polyorganosiloxanes and catalyst component (C), a polyorganosiloxane devoid of reactive groups and having a viscosity of less than 2000 mPa·s at 25° C., or a combination of two or more thereof.

20. The composition of claim 1 comprising:
100 pt. wt of component (A),
0.1 to about 10 pt. wt of at least one crosslinker (B),
0.01 to about 7 pt. wt. of a catalyst (C),
0.1 to about 5 pt. wt. of an adhesion promoter (D),
0 to about 300 pt. wt of component (E),
0.01 to about 8 pt. wt. of component (F),
whereby this composition can be stored in the absence of humidity and is curable in the presence of humidity upon exposure to ambient air.

21. A cured polymer formed from the composition of claim 1.

22. The cured polymer of claim 21 in the form of an elastomeric, seal, duromeric seal, an adhesive, a coating including anti-fouling coating, an encapsulant, a shaped article, a mold, or an impression material.
